(19) United States
(12) Patent Application Publication
(10) Pub. No.: US 2009/0188283 A1
(43) Pub. Date: Jul. 30, 2009

(54) SAFETY AND BURGLARPROOF TRANSVERSAL LOCK

(76) Inventor: Yueh-Chiac HSU, Taipei Hsien (TW)

Correspondence Address: Yueh-Chiac HSU, 235 Chung - Ho Box 8-24, Taipei, 235, TW

(21) Appl. No.: 12/022,142

(22) Filed: Jan. 29, 2008

(51) Int. Cl. E05B 13/10

(52) U.S. Cl. 70/224

(57) ABSTRACT

A safety and burglarproof lock comprises a handle seat having a front sheet, a rear sheet, two lateral sheets; each of the front sheet and rear sheet having at least one lock hole; each of the two lateral sheets having a slot, each of the front, rear and lateral sheets having a plurality of through holes; a teethed wheel having a teethed protrusion, a protrusion cylinder protruded from a front end of the teethed protrusion and a post protruded from the front end of the teethed protrusion and aside the protrusion cylinder; the teethed wheel having a rectangular hole; the protrusion cylinder being engaged to the through hole of the front sheet; a latch having a guide groove and a stud; an elastic unit for connecting the stud and the post; a lock core having a keyhole and outer threads; and a horizontal handle having a spindle.

### FIELD OF THE INVENTION

The present invention relates to locks, and in particular to a safety and burglarproof lock. A teethed wheel of the handle seat of the lock has a teethed protrusion and a rectangular hole for combining with a lock core, a head or a handle so as to have the function of opening or closing a door,

### BACKGROUND OF THE INVENTION

The general lock has a complicate structure so that the cost is high and the assembly work is tedious. Furthermore the precision in assembly is high. This further increases the cost in labor and cost. Furthermore too many parts are used and are easy to wear. Moreover, the destroy of any part will make the whole lock being malfunction so as to lose the function of burglarproof.

Therefore, there is an eager demand for a novel one to improve the defect in the prior art.

### SUMMARY OF THE INVENTION

Accordingly, the primary object of the present invention is to provide a safety and burglarproof lock comprising a handle seat which is installed with a teethed wheel and a latched. With the installing of a lock core and a head, the cost can be reduced and the assembled speed is increased with less faults.

To achieve above objects, the present invention provides a safety and burglarproof lock comprising a handle seat having a front sheet, a rear sheet, two lateral sheets; each of the front sheet and rear sheet having at least one lock hole; each of the two lateral sheets having a slot, each of the front, rear and lateral sheets having a plurality of through holes; a teethed wheel having a teethed protrusion, a protrusion cylinder protruded from a front end of the teethed protrusion and a post protruded from the front end of the teethed protrusion and aside the protrusion cylinder; the teethed wheel having a rectangular hole; the protrusion cylinder being engaged to the through hole of the front sheet; a latch having a guide groove and a stud; an elastic unit for connecting the stud and the post; a lock core having a keyhole and outer threads; the keyhole serving for receiving a key; one side of the lock core having an actuating block; the lock core having a locking hole; the actuating block being locked into the locking hole of the lock core; a horizontal handle having a spindle which is engaged to the rectangular hole of the teethed wheel; wherein when the horizontal handle is driven, the post of the teethed wheel will move in the guide groove of the latch so that the latch moves to protrude out or reduced into the handle seat to have the effect of latching or opening the door.

The various objects and advantages of the present invention will be more readily understood from the following detailed description when read in conjunction with the appended drawing.

### BRIEF DESCRIPTION OF THE DRAWINGS

FIG. 1 is an exploded perspective view the present invention.

FIG. 2 is an assembled perspective view of the present invention.

FIG. 3 is a schematic view about the horizontal handle of the present invention.

FIG. 4 shows the operation of the present invention.

FIG. 5 shows another operation of the present invention.

FIG. 6 is a schematic view showing the application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

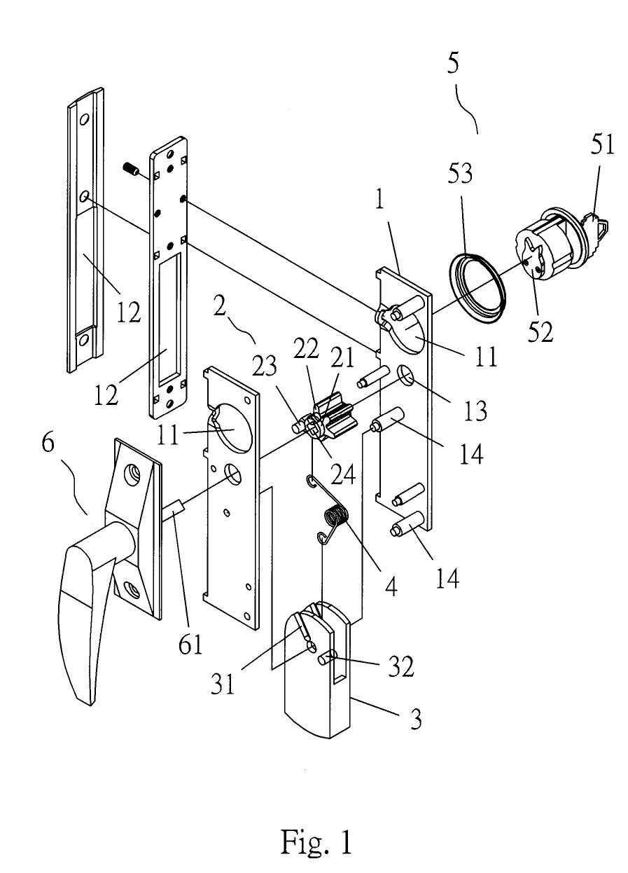

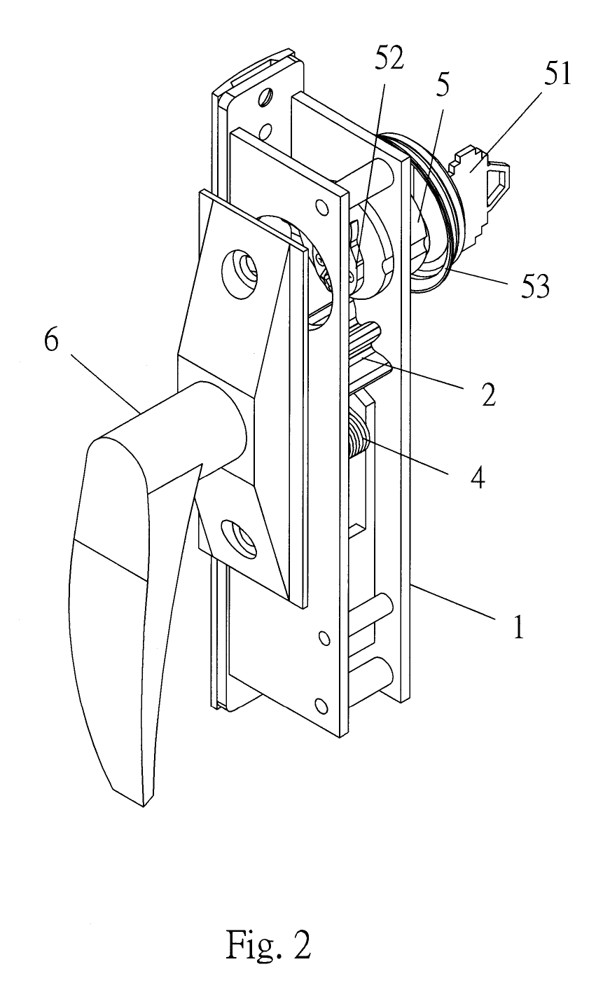

Referring to FIGS. 1 and 2, the structure of the present invention is illustrated. The present invention includes the following elements.

A handle seat 1 has a front sheet, a rear sheet, two lateral sheets. Each of the front sheet and rear sheet has at least one lock hole 11. Each of the two lateral sheets has a slot 12, Each of the front, rear and lateral sheets has a plurality of through holes 13 and the rear sheet has a plurality of rivets 14.

A teethed wheel 2 has a teethed protrusion 22, a protrusion cylinder 21 protruded from a front end of the teethed protrusion 22 and a post 23 protruded from the front end of the teethed protrusion 22 and aside the protrusion cylinder 21. The teethed wheel 2 has a rectangular hole 24 The protrusion cylinder 21 is engaged to the through hole 13 of the front sheet.

A latch 3 has a guide groove 31 and a stud 32. The rivets 14 of the handle seat 1 serve to lock the latch 3 to the handle seat 1.

An elastic unit 4 serves to connect the stud 32 and the post 23.

A lock core 5 has a keyhole and outer threads. The keyhole serves for receiving a key 51. One side of the lock core 5 has an actuating block 52. The lock core 5 has a locking hole. The actuating block 52 is locked into the locking hole of the lock core 5.

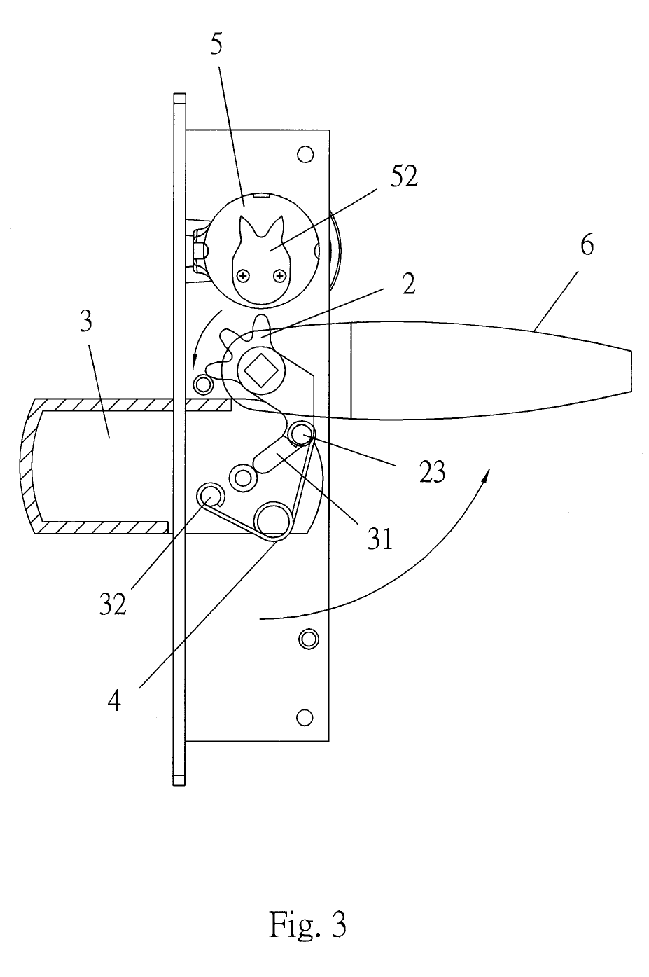

A horizontal handle 6 has a spindle 61 which is engaged to the rectangular hole 24 of the teethed wheel 2. Referring to FIGS. 1 and 3, when the spindle of the horizontal handle 6 passes through the rectangular hole 24 of the teethed wheel 2, the horizontal handle 6 is driven, and the post 23 of the teethed wheel 2 will move in the guide groove 31 of the latch 3 so that the latch 3 moves to protrude out or reduced into the handle seat 1 to have the effect of latching or opening the door.

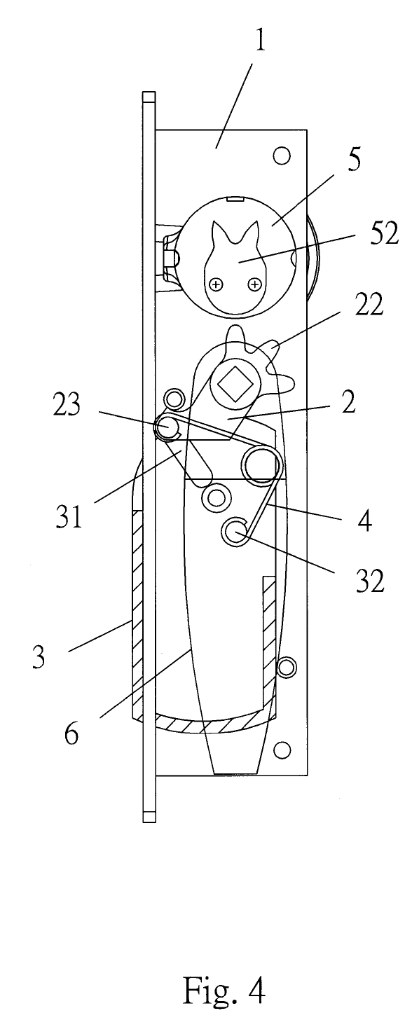

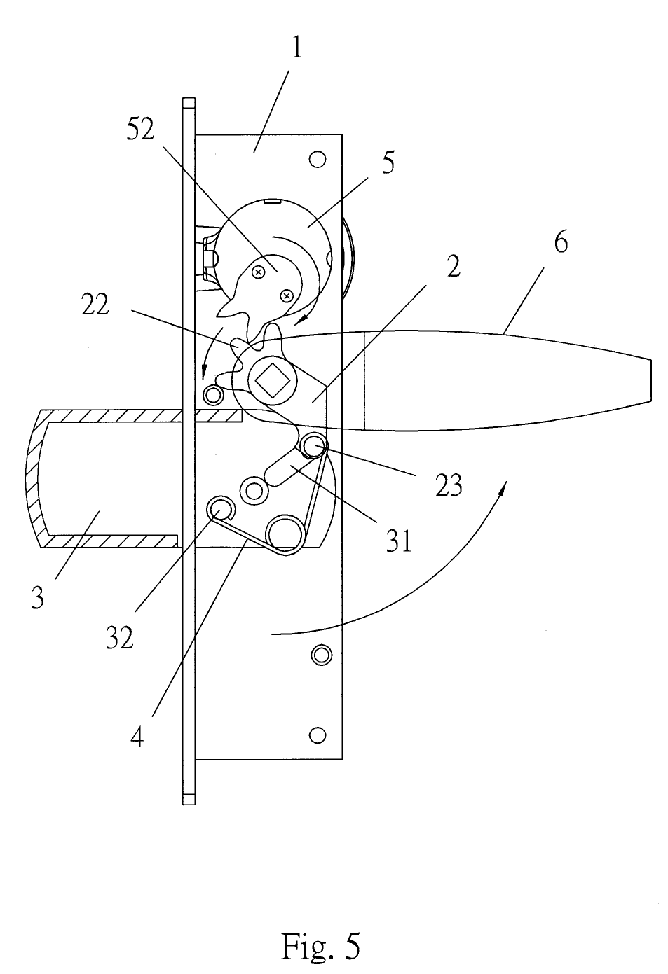

Referring to FIGS. 4 and 5, the actuating block 52 of the lock core 5 will drive the teethed protrusion 22 of the teethed wheel 2 to drive the post 23 of the teethed wheel 2 to move in the guide groove 31 of the latch 3. Thus, the elastic unit 4 extends so that the stud 32 will move. Then the latch 3 protrudes out and at the same time, the horizontal handle 6 rotates through an angle. Similarly, when the actuating block 52 of the lock core 5 moves to another side of the teethed protrusion 22, the post 23 of the teethed wheel 2 will move in the guide groove 31 of the latch 3 so that the elastic unit 4 is extended from another side and thus the elastic unit 4 will drive the stud 32 to move. Thus the latch 3 will reduce into the handle seat 1. Meanwhile, the horizontal handle 6 will return to the original position.

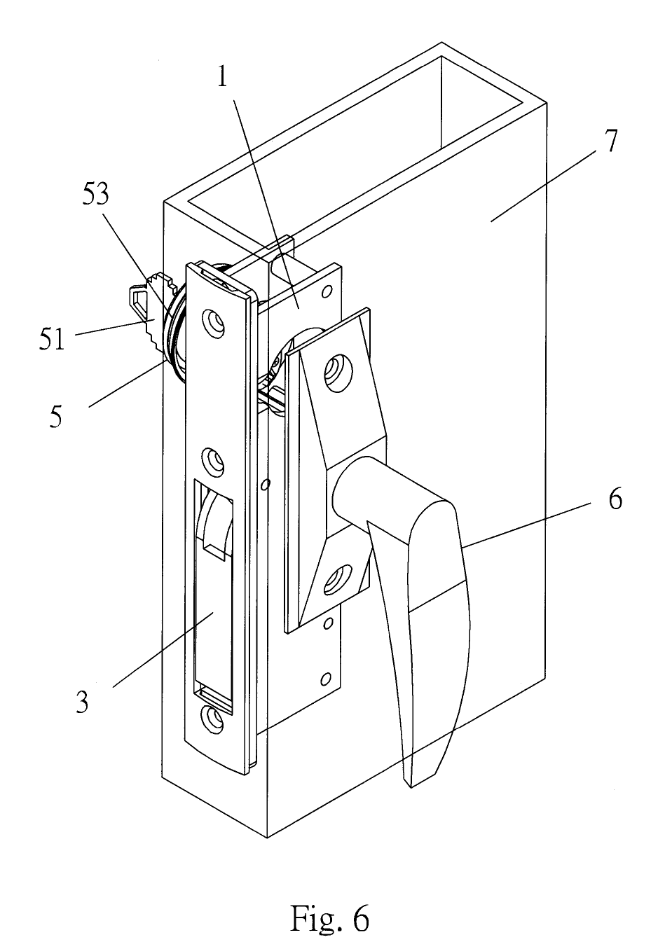

Referring to FIGS. 1 and 6, the lock of the present invention can be combined with a doorplate 7. The handle seat 1 is installed in the doorplate 7. An outer side of the doorplate 7 is combined with the lock core 5 and the horizontal handle 6. A toggle 53 encloses around the lock core 5.

Advantages of the present invention will be described herein. The structure of the present invention is easy. The assembly is simple and it can be produced massively. The lock core and lock head is replaceable. Furthermore the cost is low.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A safety and burglarproof lock comprising:
a handle seat having a front sheet, a rear sheet, two lateral sheets; each of the front sheet and rear sheet having at least one lock hole; each of the two lateral sheets having a slot, each of the front, rear and lateral sheets having a plurality of through holes;
a teethed wheel having a teethed protrusion, a protrusion cylinder protruded from a front end of the teethed protrusion and a post protruded from the front end of the teethed protrusion and aside the protrusion cylinder; the teethed wheel having a rectangular hole; the protrusion cylinder being engaged to the through hole of the front sheet;
a latch having a guide groove and a stud;
an elastic unit for connecting the stud and the post;
a lock core having a keyhole and outer threads; the keyhole serving for receiving a key; one side of the lock core having an actuating block; the lock core having a locking hole; and the actuating block being locked into the locking hole of the lock core;
a horizontal handle having a spindle which is engaged to the rectangular hole of the teethed wheel; wherein when the horizontal handle is driven, the post of the teethed wheel will move in the guide groove of the latch so that the latch moves to protrude out or reduced into the handle seat to have the effect of latching or opening the door.

2. The safety and burglarproof lock as claimed in claim 1, wherein the spindle of the horizontal handle passes through the rectangular hole of the teethed wheel.

3. The safety and burglarproof lock as claimed in claim 1, wherein the rear sheet has a plurality of rivets; the rivets locks the latch to the handle seat.

4. The safety and burglarproof lock as claimed in claim 1, wherein the teethed wheel is protruded with a protrusion cylinder which is buckled to the handle seat.

5. The safety and burglarproof lock as claimed in claim 1, wherein when the horizontal handle is driven, the post of the teethed wheel will move in the guide groove of the latch so that the latch moves to protrude out or reduced into the handle seat to have the effect of latching or opening the door.
